(19) United States
(12) Patent Application Publication
(10) Pub. No.: US 2001/0007960 A1
(43) Pub. Date: Jul. 12, 2001

(54) Network system for composing music by collaboration of terminals

(75) Inventors: Shinji Yoshihara, Hamamatsu (JP); Masahiko Wakita, Hamamatsu (JP); Tom Jen Tsai, Hamamatsu (JP)

Correspondence Address: David L. Fehrman, Morrison & Foerster LLP, Suite 3500, 555 West Fifth Street, Los Angeles, CA, 90013-1024, US

(73) Assignee: Yamaha Corporation

(21) Appl. No.: 09/754,441

(22) Filed: Jan. 4, 2001

(30) Foreign Application Priority Data
Jan. 10, 2000 (JP) 2000-35862

(51) Int. Cl. G06F 17/00

(52) U.S. Cl. 700/94

(57) ABSTRACT

A network system is designed for composing music data representative of a music composition according to composing data representative of a material of the music composition. The network system is constructed by a plurality of information processing terminals and a control station for mutually connecting the plurality of the information processing terminals through the control station. In each information processing terminal, a conversation section can be operated to exchange messages with other information processing terminal, and an input section can be operated to input the composing data while exchanging the messages with other information processing terminal. The central station composes and edits the music data according to the composing data inputted by the plurality of the information processing terminals to thereby collaborate the plurality of the information processing terminals for creating the music composition. The control station feeds back the composed music data to each information processing terminal such that each information processing apparatus can input further composing data of the fed music data.

### BACKGROUND OF THE INVENTION

(i) Field of the Invention

The present invention relates to a system, method and recording medium for composing music data, particularly for composing music data by collaboration of a plurality of persons.

(ii) Description of Related Art

In a conventional music data composition apparatus, one user composes a musical work, collaboration by a plurality of persons is impossible, good idea may not be easily created by one person, and in this manner there are limitations in music composition.

### SUMMARY OF THE INVENTION

The present invention has been developed in consideration of the aforementioned drawbacks of the related art, and an object of the invention is to provide a music data composition system in which a chat function is used to collect ideas of a plurality of users and to enable collaboration in preparation of music data by the plurality of users, each user can access common music data, and further one of the users is allowed to take leadership entirely in composition of the music data so that music data collaborating operation by the plurality of users can easily be managed.

In a main aspect of the present invention, a system is designed for composing music data representative of a music composition according to composing data representative of a material of the music composition, the system comprising a plurality of information processing terminals and a control station for mutually connecting the plurality of the information processing terminals through the control station, wherein each information processing terminal comprises a conversation section that can be operated to exchange messages with other information processing terminal and an input section that can be operated to input the composing data while exchanging the messages with other information processing terminal, and wherein the control station comprises a composing section that composes and edits the music data according to the composing data inputted by the plurality of the information processing terminals to thereby collaborate the plurality of the information processing terminals for creating the music composition. Preferably, the control station further comprises a control section that exclusively controls the inputting of the composing data among the plurality of the information processing terminals such that only one information processing terminal is allowed to input the composing data at one time to avoid conflict of the composing data among the information processing terminals. Preferably, the control station further comprises a public storage section for storing the music data such as to make the music data available publicly.

In an additional aspect of the present invention, the control station or a server apparatus further comprises a feedback section that feeds back the edited music data to the plurality of the information processing terminals or client apparatuses so that each client apparatus can collaborate with other client apparatus for creating the music composition by repetition of the transmitting of the composing data and the receiving of the music data. Preferably, each client apparatus further comprises a downloading section that downloads a program from the server apparatus so as to install an interface by the downloaded program for transmitting the composing data and receiving the music data. Preferably, each client apparatus further comprises an output section for displaying the received music data in the form of a score of the music composition, so that the input section can input the composing data in the form of music symbols superposed on the displayed score of the music composition.

In a further aspect of the present invention, the client apparatuses include a child client apparatus and a parent client apparatus that has a higher capability of inputting the composing data than the capability of the child client apparatus, thereby allowing the parent client apparatus to precede the child client apparatus in the creation of the music composition. Preferably, only the parent client apparatus can instruct the server apparatus to register the music composition while the child client apparatus is allowed to download the music data of the registered music composition from the server apparatus.

According to the main aspect of the present invention, a system provided with a chat function is constructed, a plurality of users operating a plurality of information processing terminals (client PCs), respectively, have chats with one another by exchanging conversation data (messages), and simultaneously input composing data (partial music data such as a note), and music data is composed based on these composing data. Therefore, a plurality of persons can present ideas to compose a musical work.

According to the additional aspect of the present invention, in a system constituted of a plurality of client apparatuses and a server apparatus, composing data is inputted on the client apparatus, music data is composed on the server apparatus in accordance with an instruction from the client apparatus, and the latest music data is displayed in the respective client apparatuses. Therefore, the common music data is accessed from the respective client apparatuses, so that music notes can be inputted, edited, and displayed, and collaboration is possible by a plurality of users who operate the plurality of client apparatuses, respectively.

According to the further aspect of the present invention, parentage is set in a plurality of client apparatuses, and an executable function is allowed to differ between parent and child. Typically, the parent client apparatus is set to be multifunctional. Therefore, the user of the parent client apparatus can take leadership entirely in music data preparation, and collaborating operation by the plurality of users can easily be managed.

### BRIEF DESCRIPTION OF THE DRAWINGS

FIG. 1 is a functional block diagram of the music data composition system according to one embodiment of the present invention.

FIG. 2 is a block diagram showing a hardware constitution of a server apparatus in the music data composition system according to one embodiment of the present invention.

FIG. 3 is a block diagram showing a hardware constitution of each client PC in the music data composition system according to one embodiment of the present invention.

FIG. 4 shows one example of a display screen on the client PC according to one embodiment of the present invention.

FIG. 5 shows another example of the display screen on the client PC according to one embodiment of the present invention.

FIG. 6 is a flowchart showing a process executed in a server apparatus for composing music data according to one embodiment of the present invention.

FIG. 7 is a flowchart showing a process executed in the client PC for composing the music data according to one embodiment of the present invention.

FIG. 8 is a flowchart showing a chat process executed in the server apparatus and a chat function process executed in the client PC according to one embodiment of the present invention.

FIG. 9 is a flowchart showing a composition process executed in the server apparatus according to one embodiment of the present invention.

FIG. 10 is a flowchart showing a composition applet process executed in the client PC according to one embodiment of the present invention.

FIG. 11 is a flowchart showing a mailer process executed in the client PC according to one embodiment of the present invention.

FIG. 12 shows a display screen example of the mailer process in the client PC according to one embodiment of the present invention.

### DETAILED DESCRIPTION OF THE PREFERRED EMBODIMENTS

A preferred embodiment of the present invention will be described hereinafter in detail with reference to the drawings. Additionally, the following embodiment is simply one example, and various modifications are possible in a wide scope without departing from spirit of the present invention.

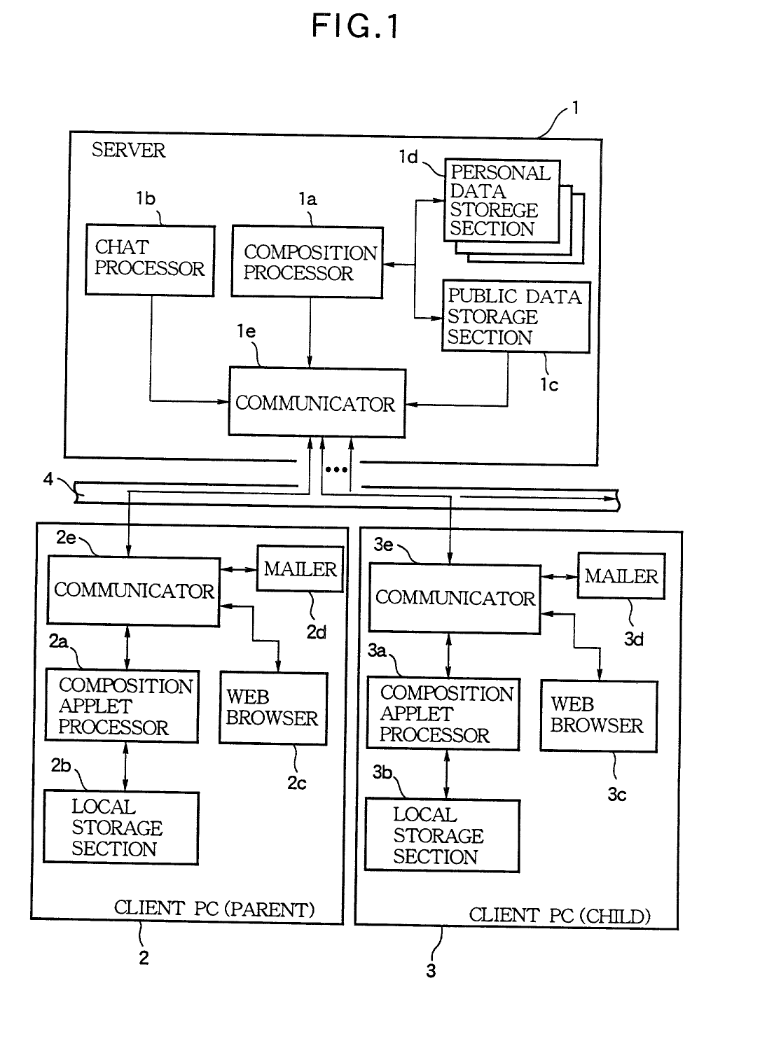

FIG. 1 shows a functional block diagram of a music data composition system according to one embodiment of the present invention. In this embodiment, the system is constituted of a server computer (hereinafter referred to simply as “server”) 1 and a plurality of client personal computers (client PCs) 2, 3, . . . (only two computers are shown in FIG. 1), the server 1 is provided with a composition processor 1a, a chat processor 1b, a public data storage section 1c, a personal data storage section 1d, and a communicator 1e. The client PCs 2, 3, . . . are provided with composition applet processors 2a, 3a, . . . , local storage sections 2b, 3b, . . . , WEB browsers 2c, 3c, . . . , mailers 2d, 3d. . . , communicators 2e, 3e, . . . , and other components.

The server 1 performs communication with the client PCs 2, 3, . . . via the communicator 1e and a communication network 4, and transmits a composition applet (program written in JAVA language) to the respective client PCs 2, 3, . . . from the chat processor 1b upon receiving an instruction for entrance to a chat room from the respective client PCs 2, 3, . . . The respective client PCs 2, 3 receive the composition applet from the communication network 4 via the communicators 2e, 3e, . . . , and the composition applet is operated by the composition applet processors 2a, 3a, . . . to perform a composition applet processing. When a composition instruction for inputting or editing music notes is performed in the respective client PCs 2, 3, . . . , the composition instruction is transmitted to the server 1 via the communicators 2e, 3e, . . . and communication network 4.

On the side of the server 1, upon receiving the composition instruction from the respective client PCs 2, 3, . . . via the communicator 1e from the communication network 4, the composition processor 1a of the server 1 composes actual music data based on the composition instruction. Specifically, only the composition instruction is performed on the side of the client PCs 2, 3, . . . , and an actual composing operation is performed on the side of the server 1. Here, the composition instruction is available from any one of the client PCs 2, 3, . . .

Additionally, in this network system, these client PCs 2, 3, . . . are provided with parentage, one of the client PCs 2, 3, . . . is set as a parent client, and the other client PCs are set as child clients. In the following, as shown in parentheses of the drawings, the client PC 2 will be designated to the parent client, and the other client PCs 3, . . . will be designated to the child clients. For example, in a simplest system constituted of two client PCs 2 and 3, one client PC 2 serves as the parent client, and the other client PC 3 serves as the child client. Additionally, three or more client PCs may be involved in the system. In this case, any one of the client PCs serves as the parent client, and other client PCs serve as the child clients. Moreover, three or more users can simultaneously enter a chat room (described later).

When any one of the client PCs 2, 3, . . . performs partial composition or arrangement, composing data (partial music data, note string, and the like) as a content of the partial composition/arrangement is also transmitted to the other client PCs via the server 1, and displayed on a monitor display. Moreover, a chat function is utilized to perform conversation among the respective client PCs 2, 3, . . . , hence the music note input and music score arrangement are advanced, and thus the music is completed.

The chat function is performed by the WEB browsers 2c, 3c, . . . of the client PCs 2, 3, . . . and the chat processor 1b of the server 1. When there is input of an message from a certain client PC, the message is transmitted and registered in the server 1, and additionally this registered message is also transmitted to other client PCs. Therefore, in the simplest system provided with the parent client PC 2 and the child client PC 3 as described above, the message from the parent client PC 2 is registered in the server 1, and transmitted to the child client PC 3. Additionally and conversely, the message from the child client PC 3 is also registered in the server 1, and transmitted to the parent client PC. In this manner, among the client PCs 2, 3, . . . , mutual messages are displayed on the displays of the respective client PCs 2, 3, . . . via the server 1, and conversation proceeds as to composition of the music.

The server 1 is provided with the public data storage section 1c as a storage area common to the users of the respective client PCs 2, 3, . . . , and provided with the personal data storage section 1d as the storage area for each user ID of the respective client PCs 2, 3, . . . , and is also provided with a temporary storage area (not shown) in the composition processor 1a. During the composing operation, the data is stored in the temporary storage area disposed in the composition processor 1a of the server 1, and upon completion of a musical work (otherwise the work may be incomplete, but in a good stopping place of the composing operation), the composed music data can be stored in the personal data storage section 1d or the public data storage section 1c of the server 1 in accordance with the instruction from the parent client PC 2.

Moreover, in this case, the parent client PC 2 can store the composed music data in its own local storage section 2b. On the other hand, the child client PCs 3, can store the music data in their own local storage sections 3b, . . . , but their data cannot be stored on the server 1. Specifically, the music data obtained by collaboration of a plurality of client PCs 2, 3, . . . is basically regarded as the data composed by the parent client PC 2, and only the parent client PC 2 is given a right to store the data on the server 1. The mailers 2d, 3d, . . . of the respective client PCs 2, 3, . . . are provided with a function of transmitting an electronic mail in which a uniform resource locator (URL) of the music data is written. The music data stored in the public data storage section 1c can be accessed by any one of the client PCs 2, 3, . . . , whether the client PC is parent or child. For example, this data can be accessed from a receiver of the electronic mail with the URL of the composed music data described therein.

Namely, the inventive system is constructed for composing music data to create a music composition according to composing instructions. The system is constructed by a plurality of client apparatuses 2, 3 and a server apparatus 1 that connects to the plurality of the client apparatuses 2, 3 through a network 4 for collaborating the plurality of the client apparatuses 2, 3 in creation of the music composition. In each of the client apparatuses 2, 3, an input section is operated for inputting composing instructions. The client apparatuses includes a child client apparatus 3 and a parent client apparatus 2 that has a higher capability of inputting the composing instructions than the capability of the child client apparatus 3. In the server apparatus, a composing section 1a composes the music data to create the music composition according to the composing instructions fed from both of the parent client apparatus 2 and the child client apparatus 3, while allowing the parent client apparatus 2 to precedes the child client apparatus 3 in the creation of the music composition. Only the parent client apparatus 2 can instruct the server apparatus 1 to register the music composition while the child client apparatus 3 is allowed to download the music data of the registered music composition from the server apparatus 1.

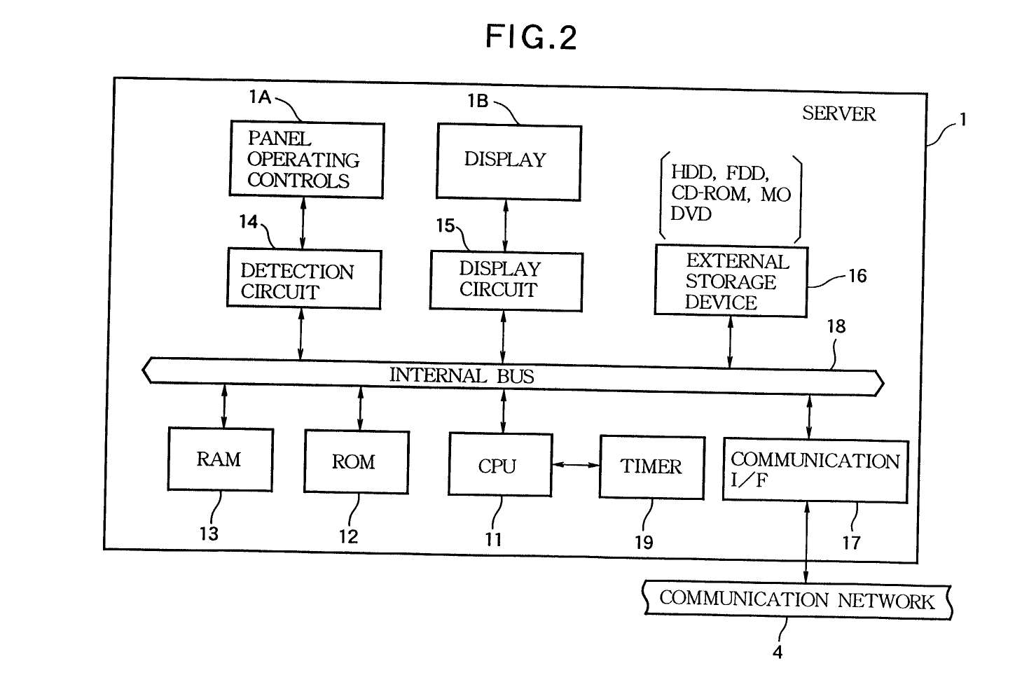

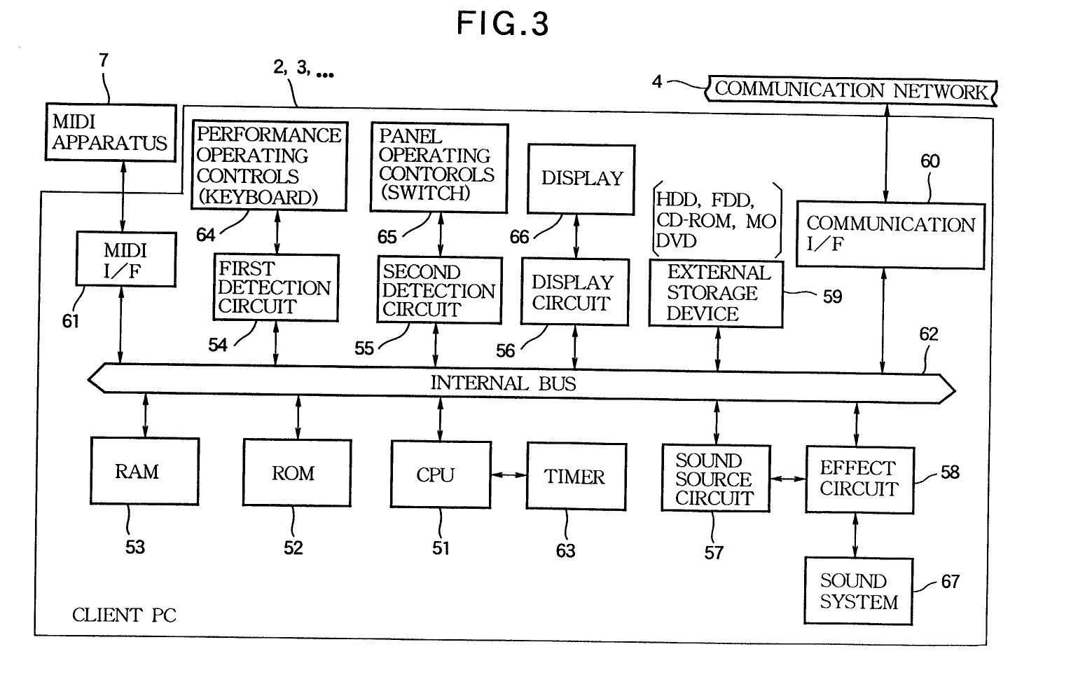

FIGS. 2 and 3 show hardware constitutions of the server and client PC in the music data composition system according to one embodiment of the present invention, a plurality of client PCs 2, 3, . . . constituting the system can employ substantially the same hardware constitution, and therefore FIG. 3 shows only one client PC. In FIG. 2, the server 1 is provided with a central processing unit (CPU) 11, a read-only memory (ROM) 12, a random access memory (RAM) 13, an operating control detection circuit 14, a display circuit 15, an external storage device 16, and a communication interface (I/F) 17, and these devices 11 to 17 are connected to one another via an internal bus 18.

The server controlling CPU 11 provided with a timer 19 performs various controls in the server in accordance with a predetermined program, and particularly executes a chat processing and a composition processing as the function of the chat processor 1b and the composition processor 1a, the music data composition processing being conducted on the side of the server 1 in a central manner. In the ROM 12, a control program for the music data composition and various data/tables are stored, and in the RAM 13 various data being processed are temporarily stored.

The operating control detection circuit 14 is connected to an operating device (keyboard, mouse, and the like) 1A including a panel switch and other operating controls, the display circuit 15 is connected to a display 1B, and the external storage device 16 is constituted of a hard disk drive (HDD) and other drive devices of transportable storage media such as a compact disk read-only memory (CD-ROM) drive, floppy disk drive (FDD), magnetooptic (MO) disk drive, and digital videodisc drive (DVD). The external storage device can store various control programs and various data including music data, and is particularly provided with a function of the personal data storage section 1d and the public data storage section 1c. The communication I/F 17 can use, for example, Ethernet or another communication interface to perform communication with a plurality of client PCs 2, 3, . . . via the communication network 4 such as LAN and Internet.

In FIG. 3, each of the client PCs 2, 3, . . . is provided with a client controlling CPU 51, ROM 52, RAM 53, first and second detection circuits 54, 55, display circuit 56, sound source circuit 57, effect circuit 58, external storage device 59, communication interface (communication I/F) 60, MIDI interface (MIDI I/F) 61, and the like, and these devices 51 to 61 are connected to one another via a bus 62.

The client controlling CPU 51 is provided with a timer 63 utilized for generation of a tempo clock or an interrupt clock, performs various controls in the client in accordance with the predetermined program, but particularly performs a WEB browser processing, chat function processing, composition applet processing and mailer processing by means of the WEB browsers 2c, 3c, . . . , composition applet processors 2a, 3a, . . . , and mailers 2d, 3d, . . . , and performs other music data composition processings on the side of the client PC in a central manner. In the ROM 52, various programs concerning the music data composition processing and various data/tables are stored, and in the RAM 53 various data being processed are temporarily stored.

A performance operating control device 64 connected to the first detection circuit 54 is provided with performance operating controls of a music keyboard type, or performance operating controls using alphanumeric keyboard keys allotted to predetermined music pitches (e.g., a group of character keys), and a panel operating control device 65 for various input settings, connected to the second detection circuit 55, is provided with a panel switch type operating element, or a switch operating element using the keyboard key (e.g., various keys except the character keys) or a mouse. The display circuit 56 is connected to a display 66 and various indicators, and on the display 66, an input setting button operable by the switch operating element can be displayed.

Moreover, a sound system 67 connected to the effect circuit 58 constituted of DSP constitutes a musical sound output section together with the sound source circuit 57 and effect circuit 58, and a musical sound can be emitted, and listened to evaluate the music during the composing operation or after the composition, or other music performance.

Similarly as the external storage device 16 of the server 1, the external storage device 59 is constituted of the HDD and the drive devices of transportable storage media, can store various control programs and various data including the music data, and is particularly provided with the function of the local storage sections 2b, 3b, . . . The respective client PCs 2, 3, . . . can use the aforementioned communication interface, modem, and the like in the communication I/F 60 to perform communication with the server 1 via the communication network 4. In this example, the respective client PCs 2, 3, . . . can further communicate with another MIDI apparatus 7 via the MIDI I/F 61, and the music I/F 61 is not limited to an exclusive MIDI interface, and may be constituted using general-purpose interfaces such as RS-232C, universal serial bus (USB), and IEEE 1394. In this case, music data other than MIDI message may also be transmitted/received at the same time.

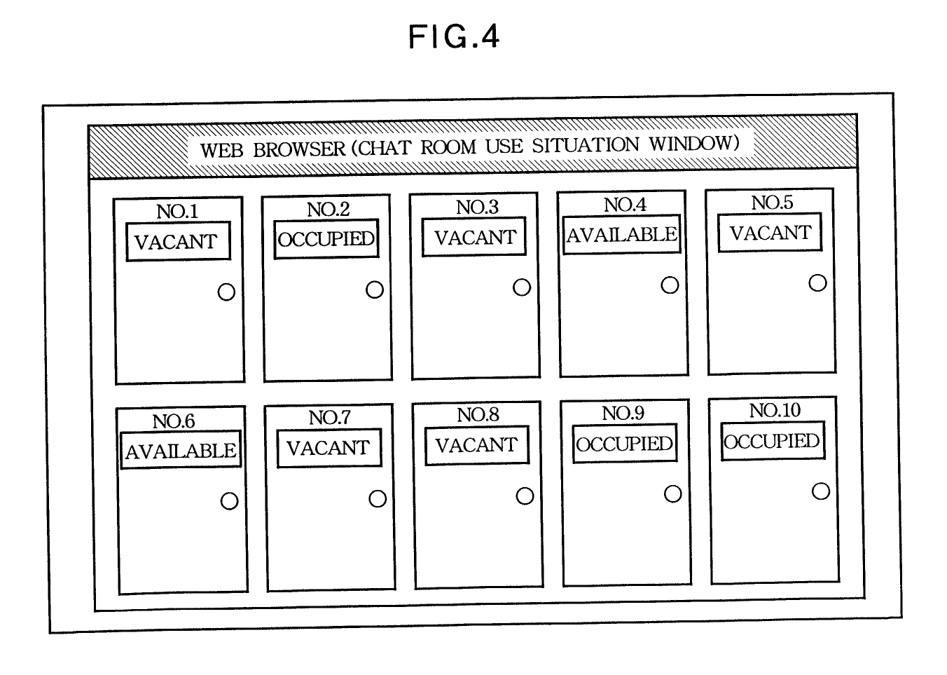

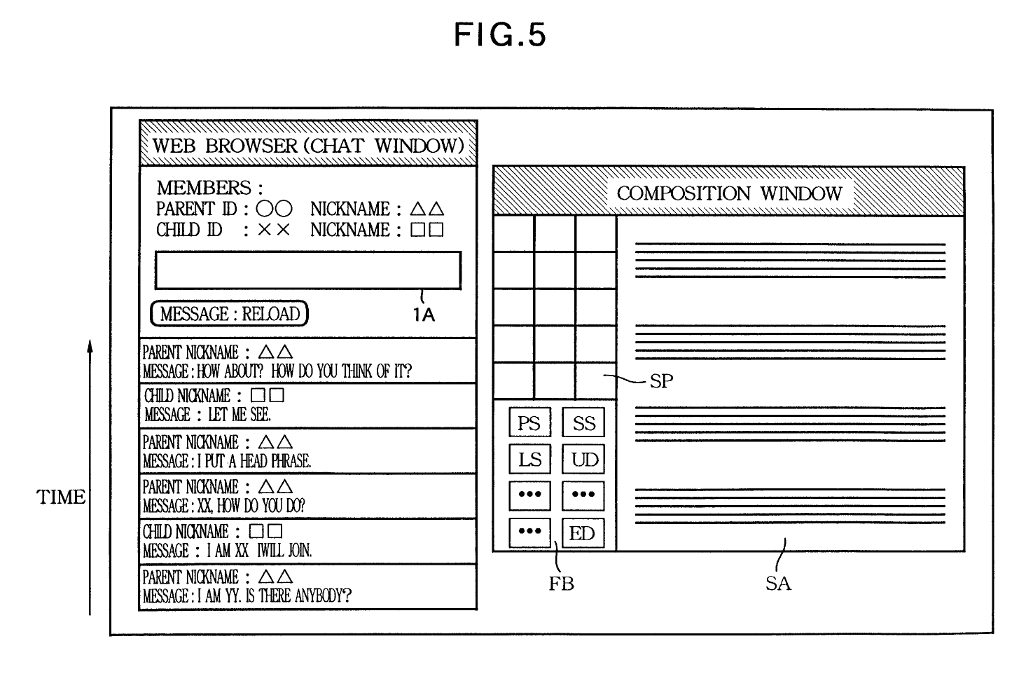

FIGS. 4 and 5 show display screen examples on the client PC according to one embodiment of the present invention. The server 1 regards a group constituted of arbitrary client PCs which perform the composing operation as “chat room”, and manages situations of one group or a plurality of groups, and the users of the respective client PCs 2, 3, . . . are given user IDs and nicknames. First, when the user starts the WEB browsers 2c, 3c, . . . , the server 1 displays a screen of “chat room use situation window” on the display 66 of the client PC as shown in FIG. 4, and notifies the respective users who intends to enter the chat room (composition group) of a chat room use situation.

In the display screen example of FIG. 4, there are ten chat rooms in total provided with room numbers “No. 1” to “No. 10” (i.e., the number of simultaneously operable working groups is ten), and terms indicating the use situations, such as “vacant”, “available” and “occupied” are displayed for the respective chat rooms. The term “vacant” indicates that one can enter the room as the parent client, and “available” indicates that the parent client has already entered the room and the child client is wanted or only additional one can enter the room. Moreover, the term “occupied” indicates that both the parent client and the child client have already entered the room and further entry is impossible, and any chat cannot be started until the “occupied” state is obtained.

Then, when the user selects/designates a chat room to enter from the rooms labeled with “vacant” or “available” displayed thereon, a display window (not shown) for inputting the user ID, and nickname opens. Subsequently, when the user ID, nickname, and the like are inputted, the inputted information is transmitted to the server, and entrance to the selected/designated chat room is permitted. Upon entrance to the chat room, “chat window” is displayed as the WEB browser on the display 66 as shown in FIG. 5, further “composition window” newly opens, and execution of chat and composing operation is made possible. The composition window is based on the composition applet sent from the server 1.

In the display screen example of FIG. 5, the “chat window” on the left side of FIG. 5 is provided with an message input area IA for performing character input of message during chat, and a “message reload” button RB for reload of the messages (registration into the server 1, and take-in and display of massages). Moreover, in a lower message display area, as shown by an arrow on the left end, a new message is successively written/added on the upper side of the previous message, and the latest message is displayed on a topmost column.

On the other hand, the “composition window” on the right side of FIG. 5 is provided with a score area SA, symbol palette SP, and multifunctional button group FB. Musical symbols such as a note and a rest are displayed in the symbol palette SP in such a manner that the symbols can be designated. The multifunctional button group FB includes a “store in server (public)” button PS, “store in server (personal)” button SS, “store in local” button LS, “store in an up-to-date state” button UD, “input/edition end” button ED, and the like, and further, though not shown, a sounding mode button for sounding of the designated note and the musical piece being composed, or a button for performing copy, deletion, movement, and other general edition processing can be included.

It is now assumed that the user of the client PC 2 enters a certain chat room as the parent client, the user of the client PC 3 enters the same chat room as the child client, and the chat room is turned “occupied” to enable the chat. This case will be described hereinafter. In this “occupied” state, the chat is possible, and the users consult with each other by the chat using the “chat window”, and utilize the composition window to proceed with composition of music.

To perform the message exchange, after inputting a sentence in the message input area IA, the “message reload” button RB is pushed. Then, the sentence inputted in the message input area IA is registered as the latest message on the side of the server 1, and the latest message is displayed on the client PC of the user having inputted the message. In this stage, the message content is not displayed on the client PC of the other user, but the other user pushes the “message reload” button RB to reload the latest message on the client PC, and can read the latest message. Additionally, the other user can register the message on the side of the server 1 by inputting a sentence in the message input area and by pushing the “message reload” button.

Additionally, there may be provided a function of automatically performing the reload every predetermined time (e.g., 30 seconds or the like). In this case, the time to be set may be fixed or be changeable by the user.

In order to input/edit the composing data (partial music data) and perform the composition, a desired symbol is selected/designated from various musical symbols displayed in the musical symbol palette SP of the composition window (the right side of FIG. 5), and the selected/designated symbol is pasted onto a music score displayed in the score area SA by drag/drop or another operation by the panel operating control device 66 (mouse or the like). Alternatively, by operating the music keyboard operating element or the alphanumeric keyboard character key group used as the performance operating control device 65 in the respective client PCs 2, 3, music notes may be inputted (additionally, when the character key group is used, the predetermined pitch is assigned to each character key). Additionally, by operating various editing buttons in the multifunctional button group FB, the copy, deletion, movement or another edition is possible.

Here, while a certain user is performing input/edition, the remaining users may be prohibited from performing the input/edition. Specifically, while one of the users of the parent client PC 2 and child client PC 3 performs the input/edition with respect to the music data, the other user may be prohibited from performing the input/edition. For example, by pushing the “input/edition end” button ED in the multifunctional button group FB in the composition window, the other client PC may be allowed to perform the input/edition. Moreover, a display may be controlled to the effect that while one member is performing the input/edition, another member cannot perform the input/edition.

The user can see the state of the input/edition performed by oneself on the own client PC, but cannot see the content of the input/edition by the other user (partner) as it is. To display the content of the result inputted/edited by the partner, the “update in up-to-date state” button UD in the multifunctional button group of the composition window is pushed. Additionally, this is not limitational, and automatic update may be performed every predetermined time, or update may be performed synchronously with reload of the chat message.

As described above, and referring back to FIGS. 1, 2 and 3, the inventive system is designed for composing music data representative of a music composition according to composing data representative of a material of the music composition. The system is constructed by a plurality of information processing terminals 2, 3, . . . , and a control station 1 for mutually connecting the plurality of the information processing terminals 2, 3 through the control station 1. In each information processing terminal 2, a conversation section 2e can be operated to exchange messages with other information processing terminal 3, and an input section 64 and 65 can be operated to input the composing data while exchanging the messages with other information processing terminal 3. In the central station 1, a composing section 1a composes and edits the music data according to the composing data inputted by the plurality of the information processing terminals 2, 3 to thereby collaborate the plurality of the information processing terminals 2, 3 for creating the music composition. Preferably, the control station 1 exclusively controls the inputting of the composing data among the plurality of the information processing apparatuses 2, 3 such that only one information processing terminal is allowed to input the composing data at one time to avoid conflict of the composing data among the information processing apparatuses 2, 3. Preferably, the control station is provided with a public storage section 1e for storing the music data such as to make the music data available publicly. Further, the control station 1 feeds back the composed music data to each information processing terminal 2, 3 such that each information processing apparatus 2, 3 can input further composing data of the fed music data.

In the embodiment of the present invention, internal data of the musical composition handled on the server 1 is not based on a general MIDI form, but is based on a general-purpose text type form. In this internal data form, fine sound representation of sound volume or timing cannot be described, but there is an advantage that the music data can be handled by a simple program of a text editor or the like.

For example, with a note string containing “C3 of a quarter note”→“D3 of a quarter note”→“E3 of an eighth note”→“an eighth rest”→“D3 of a quarter note”, in the embodiment of the present invention, “nqC3. nqD3. neE3. re. nqD3” is described as the internal data form. Here, “n” denotes “note”, “q” denotes “quarter”, “e” denotes “eighth”, “r” denotes “rest”, and “.” denotes each note end position. Similarly, “half” is represented by “h”, “whole” is represented by “w”, and “sixteenth” is represented by “s”.

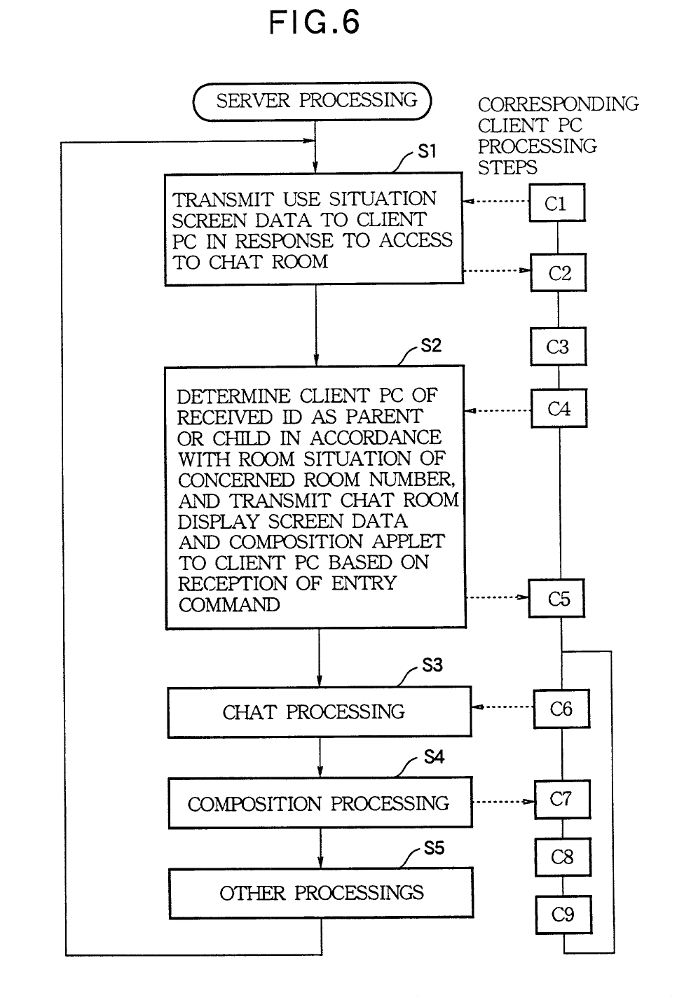

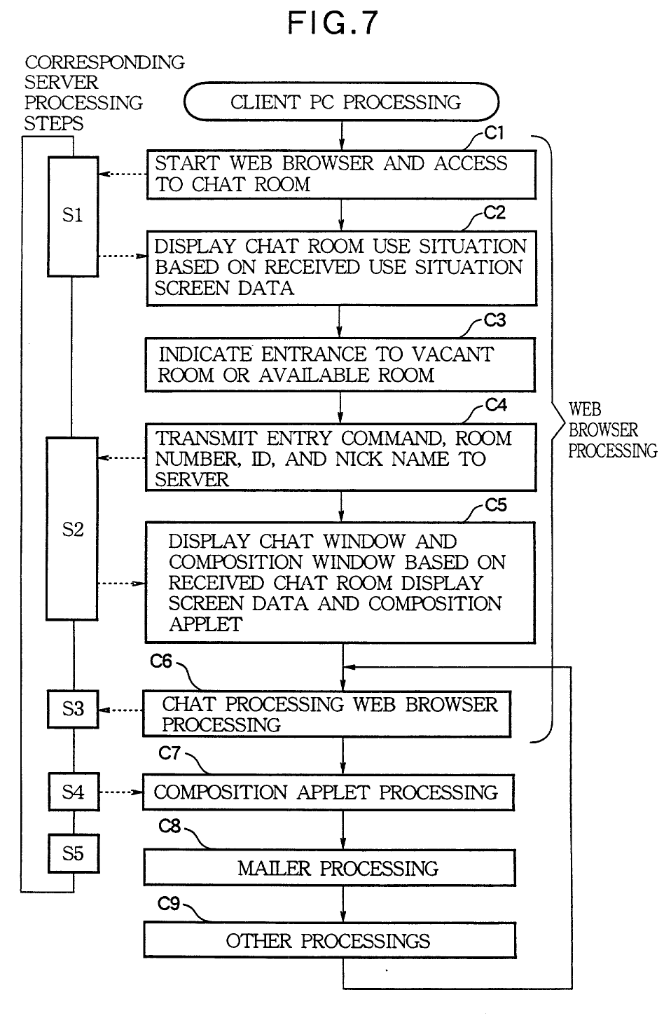

FIGS. 6 and 7 are flowcharts showing a server processing and client PC processing performed by the server and client PC for music data composition, respectively, according to one embodiment of the present invention. First, on the side of the client PCs 2, 3, . . . , a WEB browser processing is executed in first to fifth steps C1 to C5 in a client PC processing flow of FIG. 7, and at the same time, on the side of the server 1, first to third steps S1 to S3 are executed in a server processing flow of FIG. 6.

In the first step C1 of the client PC processing (FIG. 7), the client PC users start the WEB browsers 2c, 3c, . . . and access the chat room, while in the first step S1 of the server processing (FIG. 6), the server 1 transmits the room use situation screen data to the client PC in response to the access to the chat room. On the client PC side, based on the received use situation screen data, the “chat room use situation window” is displayed on the display 66 as shown in FIG. 4 (step C2: FIG. 7), and the client PC user is notified of the chat room use situation.

Subsequently, when the user selects/designates a room number from the “vacant” or “available” chat rooms and indicates entrance to the desired chat room (step C3: FIG. 7), “display window” (not shown) opens so that the user utilizes the “display window” to input the user ID, nickname and other information. Then, a command for entrance to the chat room, and the room number, user ID, nickname and other information are transmitted to the server (step C4: FIG. 7). On the other hand, the second step S2 of the server processing (FIG. 6) is executed on the side of the server 1.

In the step S2 (FIG. 6), based on reception of the entry command, the server 1 determines the client PC of the received user ID as either the parent client or the child client in accordance with the chat room situation of the indicated room number, and permits the client PC to enter the chat room. Subsequently, the display screen data and the composition applet of the concerning room number are transmitted to the client PC. On the client PC side, based on the received display screen data and composition applet, the “chat window” and “composition window” are displayed on the display 66 as shown in FIG. 5 (step C5: FIG. 7), and execution of the chat and composing operation by the client PC user is possible.

This chat and composing operation is achieved by successively, simultaneously and repeatedly executing a “chat function processing” of step C6 and “composition applet processing” of step C7 in the client PC (FIG. 7), and a “chat processing” of step S3 and “composition processing” of step S4 in the server (FIG. 6). Furthermore, on the server 1 side, after performing “other processings” in step S5, the flow returns to the step S1 to repeat the processing of steps S1 to S5. On the client PC side, after performing a “mailer processing” in step C8, and performing “other processings” in step C9, the flow returns to the step C6 to repeat the processing of steps C6 to C9.

Additionally, the “other processings” of the server 1 in the step S5 includes a processing for managing a plurality of chat rooms and a general processing of the server computer. Moreover, the “other processings” of the client PC in the step C9 includes various setting processings based on the operation of the panel operating control device 65, and processings about various functions of a general automatic performance apparatus such as music reproduction start/stop and tempo change.

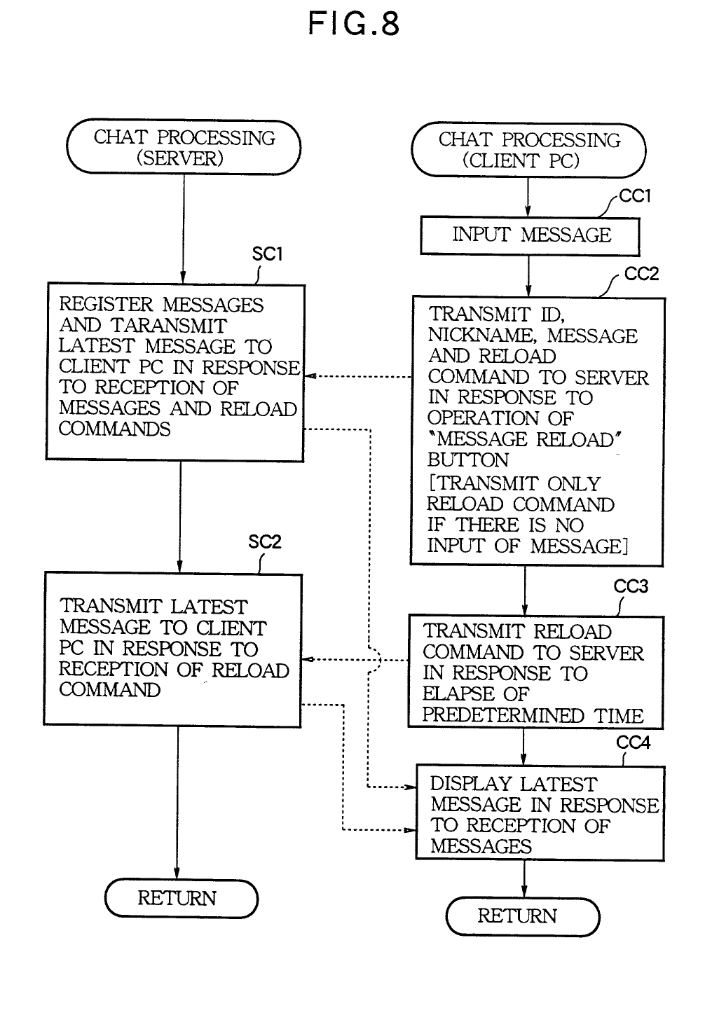

FIG. 8 is a flowchart showing the chat processing conducted in the server and the chat function processing conducted in the client PC according to one embodiment of the present invention. In FIG. 8, left-side processing flow shows in detail the “chat processing” performed by the server 1 in the step S3 of FIG. 6, and right-side processing flow shows in detail the “chat function processing” performed by the client PC in the step C6 of FIG. 7.

In a first step CC1 of the chat function processing, the client PC user uses the “chat window” shown in FIG. 5, inputs the message in the message input area IA, and operates the “message reload” button RB. Then, in a second step CC2, in response to the operation of the “message reload” button RB, the user ID, nickname, the message, and the reload command are transmitted to the server 1. Moreover, if there is no input of messages, only a reload command based on the operation of the “message reload” button RB is transmitted to the server 1. Moreover, in the next step CC3, with an elapse of a predetermined time (e.g., 30 seconds or the like as set beforehand), the reload command based on the elapse of the predetermined time is transmitted to the server 1.

On the other hand, on the server 1 side, in a first step SC1 of the chat processing, in response to reception of the message or the reload command (inputted particularly by the button RB), the message is registered, and the latest message is transmitted to the client PC of the user who has inputted the message or the user who has operated the “message reload” button RB. Moreover, in a second step SC2, in response to reception of the reload command (particularly, inputted by the elapse of time), the latest message is transmitted to the client PC of the user who has transmitted the reload command, and the flow returns to the next “composition processing” (step S4: FIG. 6).

On the other hand, on the client PC side, in the step CC4 of the chat function processing, in response to reception of the latest message, the latest message is displayed on the display 66 in such a manner that the message content is displayed in the topmost column of the message display area as shown on the lower left of FIG. 5, and the flow returns to the next “composition applet processing” (step C7: FIG. 7).

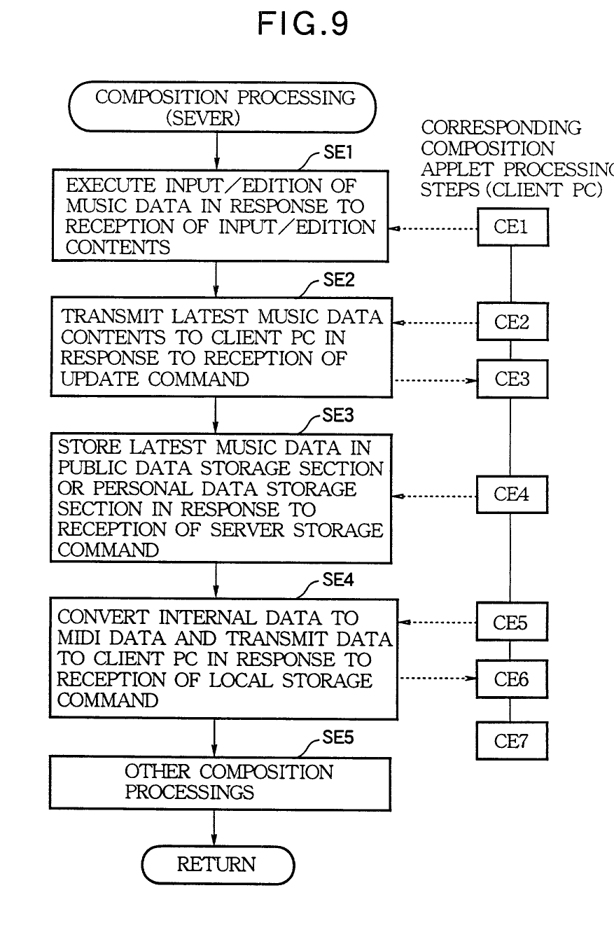

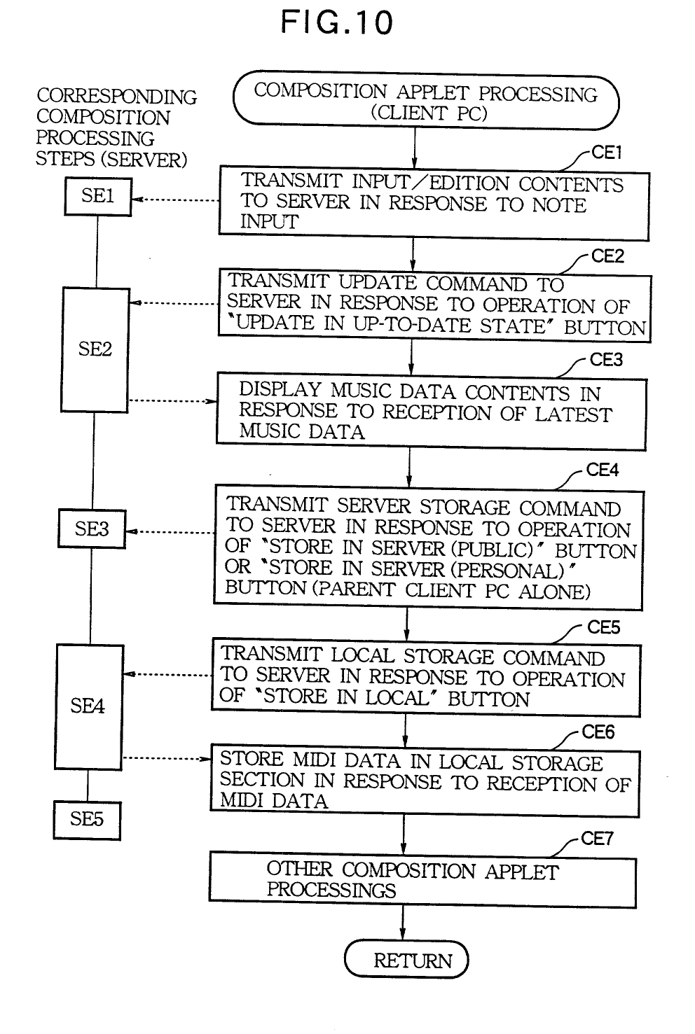

FIGS. 9 and 10 are flowcharts showing the composition processing performed in the server and the composition applet processing performed in the client PC, respectively, according to one embodiment of the present invention. The processing flow of FIG. 9 shows in detail the “composition processing” performed by the server 1 in the step S4 of FIG. 6, and the processing flow of FIG. 10 shows in detail the “composition applet processing” performed by the client PC in the step C7 of FIG. 7.

When the client PC user uses, for example, the “composition window” shown in FIG. 5, and inputs/edits the desired notes on the score area SA by the musical symbols of the musical symbol palette SP. The input, edition, and the like of the notes constitute the composition instruction, and in a first step CE1 of the composition applet processing (FIG. 10), the input/edition content is transmitted to the server 1 as occasional demands. On the server 1 side having received this, in a first step SE1 (FIG. 9) of the composition processing, in response to reception of the input/edition content, the input/edition of the music data is executed.

Moreover, when the client PC user operates the “update in up-to-date state” button UD in the multifunctional button group FB of the “composition window”, in a second step CE2 of the composition applet processing (FIG. 10), in response to the operation of the “update in up-to-date state” button UD, an update command is transmitted to the server 1. In a second step SE2 of the composition processing (FIG. 9), in response to reception of the update command, the server 1 having received this command transmits the latest music data contents to the client PC. Upon receiving the latest music data from the server 1, in a third step CE3 of the composition applet processing (FIG. 10), the client PC displays the received music data contents, for example, on the score area SA of the “composition window”.

As described above, and referring back to FIGS. 1, 2 and 3, the inventive system is designed for editing music data to create a music composition according to composing data representative of a material of the music composition. The inventive system is constructed by a plurality of client apparatuses 2, 3 and a server apparatus 1 that connects to the plurality of the client apparatuses 2, 3 through a network 4 to communicate with the plurality of the client apparatuses 2, 3. In each client apparatus 2, an interface section 2a can be operated to transmit composing data and to receive music data. In the server apparatus 1, a composing section 1a edits the music data according to the composing data fed from the plurality of the client apparatuses 2, 3, and a feedback section 17 feeds back the edited music data to the plurality of the client apparatuses 2, 3 so that each client apparatus 2 can collaborate with other client apparatus 3 for creating the music composition by repetition of the transmitting of the composing data and the receiving of the music data. Preferably, each client apparatus 2, 3 downloads a program from the server client 1 so as to install the interface section 2a by the downloaded program in each client apparatus 2 for transmitting the composing data and receiving the music data. Further, each client apparatus 2 has an output device 66 for displaying the received music data in the form of a score of the music composition and an input device 64, 65 for inputting the composing data in the form of music symbols superposed on the displayed score of the music composition.

Furthermore, for the parent client PC, when the user operates the “store in server (public)” button PS or “store in server (personal)” button SS, in step CE4 of the composition applet processing (FIG. 10), a server storage command is transmitted to the server 1 in response to the button operation. Upon receiving the server storage command from the parent client PC, in step SE3 of the composition processing (FIG. 9), the server 1 stores the corresponding music data in the public data storage section 1c or the personal data storage section 1d.

Moreover, when the client PC user operates the “store in local” button LS, in step CE5 of the composition applet processing (FIG. 10), a local storage command is transmitted to the server 1 in response to the button operation. On the other hand, upon receiving the local storage command from the client PC, in step SE4 of the composition processing (FIG. 9), the server 1 converts the music data to the MIDI data format from internal data format, then transmits the converted data to the client PC, and thereafter advances to step SE5. Upon receiving the music data of the MIDI form, in step CE6 of the composition applet processing (FIG. 10), the client PC stores the received music data of the MIDI form to the local storage section (2d, 3d, . . . ) of the client PC, and then advances to step CE7.

Subsequently, the server 1 performs “other composition processings” in step SE5 (FIG. 9), and subsequently returns to the next “other processings” (step S5: FIG. 6). Moreover, the client PC performs “other composition applet processings” including a sounding processing of the inputted note data and the music data being composed in step CE7 (FIG. 10), and subsequently returns to the next “mailer processing” (step C8: FIG. 7).

Additionally, this system may be provided with a function of uploading the music data of MIDI form in the local storage section (2d, 3d, . . . ) to the public data storage section 1c or the personal data storage section 1d on the server 1. In this case, as one processing of “other composition applet processings” of the client PC in the step CE7 or “other composition processings” of the server 1 in step SE5, the music data in the local storage section is converted to the internal data form from the MIDI data form on the client PC or the server 1.

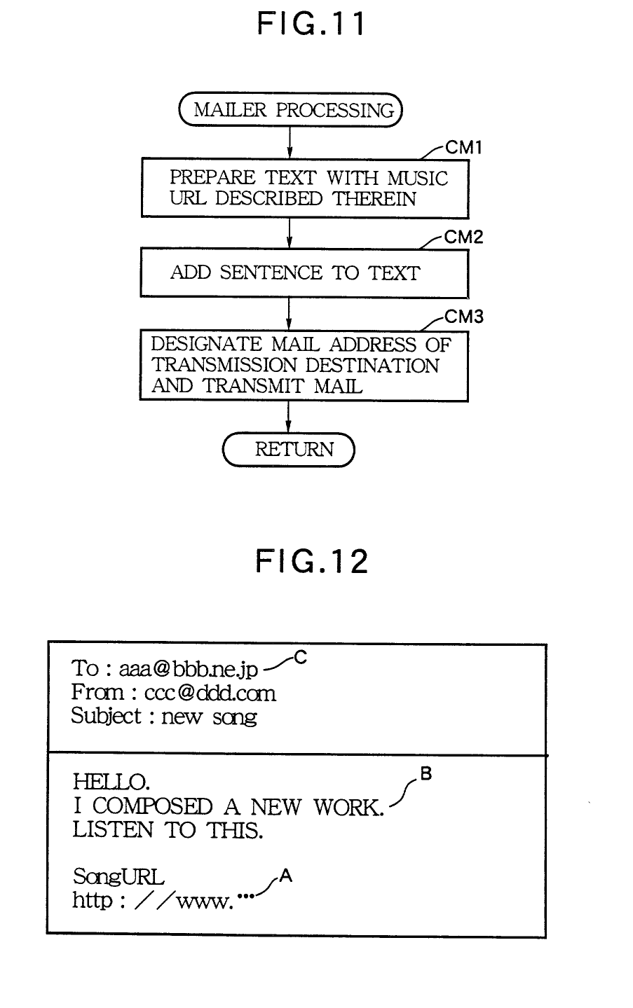

According to one embodiment of the present invention, the electronic mail with the URL of the composed music data described therein is transmitted by “mailer processing”, and utilized for access from the receiver of this electronic mail. FIG. 11 is a flowchart showing the mailer processing conducted in the client PC according to one embodiment of the present invention, and FIG. 12 shows a display screen example displayed during the mailer processing on the client PC according to one embodiment of the present invention.

The processing flow of FIG. 11 shows the “mailer processing” performed by the client PC in the step C8 of FIG. 7 in detail. In a first step CM1 of this processing flow, a text is composed such that “music URL” A indicating a location in the public data storage section 1c of the server 1 where the object music data is stored is described. In the next step CM2, a desired sentence B is added to the text, and after designating a mail address C as a transmission destination and performing transmission in step CM3, the flow returns to the next “other processings” (step C9: FIG. 7). Additionally, when there is an access to the “music URL” A from the receiver of the electronic mail, in the “other processings” (step S5: FIG. 6), the server 1 converts the music data stored in the URL from the internal form to the MIDI form, and transmits the converted music data to the client PC as the accessing receiver.

A mode for carrying out the music data composition according to the present invention has been described above with respect to one embodiment, but the composition method is not limited to that of the embodiment. For example, the mode may comprise designating a composition condition and motif to perform automatic composition, that is, designating the composition condition and motif from the respective client PCs so that composition/edition may be performed on the server side.

Moreover, the music data may be constituted of one performance part (e.g., melody), or a plurality of performance parts (e.g., melody, rhythm, bass and accompaniment). The data of the performance parts such as rhythm, bass, and accompaniment may be constituted by combining pre-stored accompaniment style data (several bars or another short pattern). Furthermore, the data may be constituted by analyzing and automatically applying melody, or applying chord progression by manual input of the user, and controlling the bass and accompaniment part to match with the chord progression.

Examples of a music data format include “event+relative time” as representation of performance event occurrence time by a time elapsed from a previous event, “event+absolute time” as representation of the performance event occurrence time by an absolute time measured in the music or the bar, “pitch (rest)+note length” as representation of music data by note pitch and note length or rest and rest length, “flat system” constituted by securing a memory area for each minimum performance resolution and by storing a performance event in the memory area at the performance event occurrence time, and other forms.

Examples of a method for recording the music data at a plurality of channels (parts) include a method of recording the data of the plurality of channels in a mixed manner, and a method of dividing and storing the respective channel data for each track. Moreover, on the memory, the music data of a time series may be stored in a continuous area, or the data stored in scattered areas may separately be managed as continuous data. Specifically, the method is not limited as long as the data can be managed as the data continuing in a time series manner, and it does not matter whether or not the data is physically continuously stored on the memory.

The client PC is not limited to a mode specified as an electronic instrument or a mode of a personal computer+application software, and a sing-alone or karaoke machine, a game machine, portable communication terminals such as a cellular phone, and an automatic performance piano may be used. With the mode specified as the electronic instrument, the client PC is not limited to a keyboard instrument, and the mode of a stringed instrument type, wind instrument type, percussion instrument type or another instrument type may be used. Moreover, instead of incorporating the sound source device, automatic performance device, and the like in one client PC main body, the respective devices are separate devices, and are connected to one another using MIDI, various networks and other communication means. Moreover, various data utilized for processing programs and various programs may be supplied to the client PC from the external storage medium, or from the external device via the communication interface.

As described above, according to the main aspect of the invention, for the music data composition system of the present invention, the system provided with the chat function is constituted in such a manner that conversation data (message) is exchanged among a plurality of information processing terminals (client PCs), the composing data (notes and other music symbols) are inputted and edited in the respective information processing terminals, and the music data is composed based on exchange of conversation data and inputted composing data. Therefore, a plurality of users who operate the plurality of information processing terminals are chatting with each other while inputting/editing the composing data to compose the music data based on the composing data, and an effect is obtained that the plurality of users present ideas to compose the musical work.

Further, in the music data composition system according to the additional aspect of the present invention, in the system constituted of a plurality of client apparatuses and the server apparatus, the conversation data is exchanged among the client apparatuses, the composing data is inputted/edited in the respective client apparatuses, and the server apparatus composes the music data based on the inputted/edited composing data, so that the composed latest music data is transmitted to the client apparatus and displayed. Therefore, the respective client apparatuses can access the common music data, and perform the score input/edition, and an effect is obtained that collaboration is possible by the plurality of users who operate the plurality of client apparatuses, respectively.

Furthermore, in the music data composition system according to the further aspect of the present invention, the parentage is set among the plurality of client apparatuses, the conversation data is exchanged among these client apparatuses, the composing data is inputted/edited in the respective client apparatuses, and the server apparatus composes the music data based on the inputted/edited composing data. Additionally, the executable functions in the parent client apparatus and child client apparatus are allowed to differ from each other (specifically, the parent client apparatus is set to be multifunctional), so that the user who operates the parent client apparatus can be provided with the leadership of the entire music data composition. Therefore, an effect is obtained that the collaborating operation by the plurality of users can easily be managed.

What is claimed is:

1. A system for composing music data representative of a music composition according to composing data representative of a material of the music composition, the system comprising
a plurality of information processing terminals and a control station for mutually connecting the plurality of the information processing terminals through the control station, wherein p2 each information processing terminal comprises a conversation section that can be operated to exchange messages with other information processing terminal, and an input section that can be operated to input the composing data while exchanging the messages with other information processing terminal, and wherein
the control station comprises a composing section that composes and edits the music data according to the composing data inputted by the plurality of the information processing terminals to thereby collaborate the plurality of the information processing terminals for creating the music composition.

2. The system according to claim 1, wherein the control station further comprises a control section that exclusively controls the inputting of the composing data among the plurality of the information processing terminals such that only one information processing terminal is allowed to input the composing data at one time to avoid conflict of the composing data among the information processing terminals.

3. The system according to claim 1, wherein the control station further comprises a public storage section for storing the music data such as to make the music data available publicly.

4. The system according to claim 1, wherein the control station further comprises a feedback section that feeds back the edited music data to the plurality of the information processing terminals so that each information processing terminal can collaborate with other information processing terminal for creating the music composition by repetition of the transmitting of the composing data and the receiving of the music data.

5. The system according to claim 4, wherein each information processing terminal further comprises a downloading section that downloads a program from the control station so as to install an interface by the downloaded program for transmitting the composing data and receiving the music data.

6. The system according to claim 4, wherein each information processing terminal further comprises an output section for displaying the received music data in the form of a score of the music composition, so that the input section can input the composing data in the form of music symbols superposed on the displayed score of the music composition.

7. The system according to claim 1, wherein the information processing terminals include a child information processing terminal and a parent information processing terminal that has a higher capability of inputting the composing data than the capability of the child information processing terminal, thereby allowing the parent information processing terminal to precede the child information processing terminal in the creation of the music composition.

8. The system according to claim 7, wherein only the parent information processing terminal can instruct the control station to register the music composition while the child information processing terminal is allowed to download the music data of the registered music composition from the control station.

9. A method of composing music data representative of a music composition according to composing data representative of a material of the music composition in a network system comprised of a plurality of information processing terminals and a control station that mutually connects the plurality of the information processing terminals through the control station, the method comprising the steps of:
exchanging messages among the plurality of the information processing terminals to conduct a conversation as to creating of a music composition;
inputting the composing data from each information processing terminal while exchanging the messages with other information processing terminal; and
composing and editing the music data at the control station according to the composing data inputted by the plurality of the information processing terminals to thereby collaborate the plurality of the information processing terminals for creating the music composition.

10. A medium containing a program executable in a network system for composing music data representative of a music composition according to composing data representative of a material of the music composition, the network system comprising a plurality of information processing terminals and a control station that mutually connects the plurality of the information processing terminals through the control station, wherein the program is executed to cause the network system to perform a method comprising the steps of:
exchanging messages among the plurality of the information processing terminals to conduct a conversation as to creating of a music composition;
inputting the composing data from each information processing terminal while exchanging the messages with other information processing terminal; and
composing and editing the music data at the control station according to the composing data inputted by the plurality of the information processing terminals to thereby collaborate the plurality of the information processing terminals for creating the music composition.

11. A server apparatus for composing music data representative of a music composition according to composing data, which represents a material of the music composition and which is transmitted from a plurality of client apparatuses, the server apparatus comprising:
a chat section that enables each client apparatus to exchange messages with other client apparatus;
a receiving section that receives the composing data which is inputted by each client apparatus while each client apparatus exchanges the messages with other client apparatus; and
a composing section that composes and edits the music data according to the composing data inputted by the plurality of the client apparatuses to thereby collaborate the plurality of the client apparatuses for creating the music composition.

12. The server apparatus according to claim 11, further comprising a control section that exclusively controls the inputting of the composing data among the plurality of the client apparatuses such that only one client apparatus is allowed to input the composing data at one time to avoid conflict of the composing data among the client apparatuses.

13. The server apparatus according to claim 11, further comprising a public storage section for storing the music data such as to make the music data available publicly.

14. The server apparatus according to claim 11, further comprising a transmitting section that transmits back the edited music data to the plurality of the client apparatuses so that each client apparatus can collaborate with other client apparatus for creating the music composition by repetition of the transmitting of the composing data and the receiving of the music data.

15. The server apparatus according to claim 14, further comprising a downloading section that downloads a program to each client apparatus to install an interface by the downloaded program, thereby enabling each client apparatus to transmit the composing data and to receive the music data.

16. A method of composing music data representative of a music composition by a server apparatus according to composing data, which represents a material of the music composition and which is transmitted to the server apparatus from a plurality of client apparatuses, the method comprising the steps of:
enabling each client apparatus to exchange messages with other client apparatus;
receiving the composing data which is inputted by each client apparatus while each client apparatus exchanges the messages with other client apparatus; and
composing and editing the music data according to the composing data inputted by the plurality of the client apparatuses to thereby collaborate the plurality of the client apparatuses for creating the music composition.

17. A medium containing a program executable by a server apparatus for composing music data representative of a music composition according to composing data, which represents a material of the music composition and which is transmitted to the server apparatus from a plurality of client apparatuses, wherein the program is executed to cause the server apparatus to perform a method comprising the steps of:
enabling each client apparatus to exchange messages with other client apparatus;
receiving the composing data which is inputted by each client apparatus while each client apparatus exchanges the messages with other client apparatus; and
composing and editing the music data according to the composing data inputted by the plurality of the client apparatuses to thereby collaborate the plurality of the client apparatuses for creating the music composition.

18. A client apparatus for composing music data representative of a music composition according to composing data representative of a material of the music composition in cooperation with other client apparatus and a server apparatus mutually connecting client apparatuses, the client apparatus comprising:
an exchanging section that exchanges messages with other client apparatus via the server apparatus;
an input section that inputs the composing data while exchanging the messages with other client apparatus; and
a transmitting section that transmits the inputted composing data to the server apparatus for enabling the server apparatus to compose and edit the music data according to the transmitted composing data to thereby collaborate the client apparatuses with each other for creating the music composition.

19. The client apparatus according to claim 18, further comprises a receiving section that receives the edited music data fed back from the server apparatus so that the client apparatus can collaborate with other client apparatus for creating the music composition by repetition of the transmitting of the composing data and the receiving of the music data.

20. The client apparatus according to claim 19, further comprising a downloading section that downloads a program from the server apparatus so as to install an interface relative to the server apparatus by the downloaded program for transmitting the composing data and receiving the music data.

21. The client apparatus according to claim 19, further comprises an output section for displaying the received music data in the form of a score of the music composition, so that the input section can input the composing data in the form of music symbols superposed on the displayed score of the music composition.

22. The client apparatus according to claim 18, being designated to either of a child client apparatus and a parent client apparatus that has a higher capability of inputting the composing data than the capability of the child client apparatus, thereby allowing the parent client apparatus to precede the child client apparatus in the creation of the music composition.

23. The client apparatus according to claim 22, wherein only the parent client apparatus can instruct the server apparatus to register the music composition while the child client apparatus is allowed to download the music data of the registered music composition from the server apparatus.

24. A method of composing music data representative of a music composition by a client apparatus in cooperation with other client apparatus and a server apparatus mutually connecting client apparatuses, according to composing data which represents a material of the music composition and which is transmitted to the server apparatus from a plurality of client apparatuses, the method comprising the steps of:
exchanging messages with other client apparatus via the server apparatus;
inputting the composing data while exchanging the messages with other client apparatus; and
transmitting the inputted composing data to the server apparatus for enabling the server apparatus to compose and edit the music data according to the transmitted composing data to thereby collaborate the client apparatuses with each other for creating the music composition.

25. A medium containing a program executable by a client apparatus for composing music data representative of a music composition in cooperation with other client apparatus and a server apparatus mutually connecting client apparatuses, according to composing data which represents a material of the music composition and which is transmitted to the server apparatus from client apparatuses, wherein the program is executed by each client apparatus to perform a method comprising the steps of:
exchanging messages with other client apparatus via the server apparatus;
inputting the composing data while exchanging the messages with other client apparatus; and
transmitting the inputted composing data to the server apparatus for enabling the server apparatus to compose and edit the music data according to the transmitted composing data to thereby collaborate the client apparatuses with each other for creating the music composition.
